(19) United States
(12) Patent Application Publication
(10) Pub. No.: US 2012/0072606 A1
(43) Pub. Date: Mar. 22, 2012

(54) CONTROLLABLE INTERFACE FOR PROVIDING SECURE ACCESS TO EXTERNAL COMPUTING RESOURCES

(76) Inventors: Oleksiy Yu SHEVCHENKO, Broadlands, VA (US); Alexander V. Pyntikov, Ashburn, VA (US)

(21) Appl. No.: 12/885,762

(22) Filed: Sep. 20, 2010

(51) Int. Cl. G06F 15/16

(52) U.S. Cl. 709/229

(57) ABSTRACT

A system is provided for controlling data communication between a computing device and a network access device over a physical medium. The network access device may be configured for providing access of the computing device to a remote computing resource over a network link. The system involves a Media Access Control (MAC) device for performing a MAC protocol to support data communication between the computing device and the network access device and a physical layer (PHY) device that connects the MAC device to the physical medium. Data path circuitry is provided between the PHY device and the MAC device for transferring signals from the computing device to the network access device, and from the network access device to the computing device. The data path circuitry is controlled to establish a unidirectional signal transfer mode between the computing device and the network access device by preventing the signals from being transferred to the network access device.

### TECHNICAL FIELD

This disclosure relates to computer systems, and more particularly, to an interface between a user computing device and a network access device, controlled to provide secure access of the computer device to external computing resources.

### BACKGROUND ART

Computer networking applications require a user computing device to access external computing resources via a network link. For example, cloud computing is a new way of delivering computing resources that enables users to access computing resources provided at remote servers. By using cloud infrastructures, users can avoid capital expenditure on hardware, software, and information technology services. Cloud users pay a cloud provider only for what they use. Consumption is usually billed on a utility or subscription basis with little or no upfront cost. Other benefits of this time sharing-style approach are low barriers to entry, shared infrastructure and costs, low management overhead, and immediate access to a broad range of applications.

Another example of accessing external computing resources is grid computing that involves cooperation between a cluster of computer devices to achieve a common goal. This technology has been applied to computationally intensive scientific, mathematical, and academic problems, and is used for such diverse applications as monitoring utility units, seismic analysis, drug discovery and economic forecasting.

Access to external resources, however, comes with real dangers for users as well as providers of external resources. While using cloud infrastructures, the cloud user necessarily cedes control to the cloud provider on a number of security issues. In particular, with cloud computing, user's confidential data are processed by the cloud provider outside the user's premises. Therefore, the cloud provider must offer a commitment to provide reliable security services. However, the security measures that the cloud provider can offer are limited because the cloud provider does not have control over the cloud users computing devices that access the cloud. Computing resources offered by the cloud provider can be compromised if a malicious user or a hacker gains access to a user computing device that have valid rights to access the cloud provider's resources.

Our U.S. patent application Ser. No. 12/724,801 filed on Mar. 16, 2010, entitled “Secure Access Device for Cloud Computing,” and incorporated herewith by reference, discloses a network access device, such as a cloud secure access device, that provides user's access to remote computing resources in a manner that prevents the remote computing resources and user's data from being compromised. The network access device may create a local computing environment controlled by a provider of remote computing resources and including software applications that may be run when a user accesses remote computing resources of a particular provider via a network.

While a user operates with remote computing resources, she may need resources of her own computing device. Moreover, usability of access to remote computing resources may be improved if a user is able to access the remote computing resources using her own computing device. For example, as described in the U.S. patent application Ser. No. 12/724,801, a local computer device of a user may be connected to the network access device to facilitate operations with remote computing resources.

However, if a malicious user gains access to the local computer device, the remote computing resources may be compromised. Moreover, data stored in a local computer device of a non-malicious user, such as banking account or credit card information, may be compromised by malware transferred from the network. In addition, a key logging software may be planted into the local computing device from the network.

For example, recent study of researchers at MIT's Computer Science and Artificial Intelligence Laboratory and the University of California at San Diego probed Amazon's Elastic Computer Cloud (EC2) service and discovered potential weaknesses in the basic computing infrastructure services that involve virtual machines. The attack involves first figuring out which physical servers a victim is using within a cloud, then implanting a malicious virtual machine there, and finally attacking the victim. The researchers demonstrated that, once the malicious virtual machine is placed on the same server as its target, it is possible to monitor how access to resources fluctuates and thereby potentially glean sensitive information about the victim.

Therefore, to improve usability of user's access to remote computing resources, it would be desirable to enable a user to connect her computing device to the remote computing resources. However, to prevent the remote computing resources and data in the user computing device from being compromised, the access of the user's computing device should be controlled.

### SUMMARY OF THE DISCLOSURE

The present disclosure offers a system for controlling data communication between a user computing device and a network access device over a physical medium. The network access device may be configured for providing access of the computing device to a remote computing resource over a network link.

The system comprises a Media Access Control (MAC) device for performing a MAC protocol to support data communication between the computing device and the network access device. A physical layer (PHY) device connects the MAC device to the physical medium. Data path circuitry is provided between the PHY device and the MAC device for transferring first signals from the computing device to the network access device, and second signals from the network access device to the computing device. The data path circuitry is controlled to establish a unidirectional signal transfer mode between the computing device and the network access device by preventing the first signals from being transferred to the network access device.

In one exemplary embodiment, the MAC device may be coupled to the network access device for providing a MAC address to identify the network access device. The data path circuitry may be provided between the MAC device and the PHY device to transfer transmit signals from the network access device to the physical medium and to transfer receive signals from the physical medium to the network access device. The data path circuitry may be controlled to prevent the receive signals from being transferred to the MAC device.

In another exemplary embodiment, the MAC device may be coupled to the computing device to provide a MAC address identifying the computing device. The data path circuitry may be provided between the MAC device and the PHY device to transfer transmit signals from the computing circuit to the physical medium and to transfer receive signals from the physical medium to the computing device. The data path may be controlled to prevent the transmit signals from being transferred to the PHY device.

In accordance with one aspect of the disclosure, the data path circuitry may include a multi-bit data interface for providing parallel transmission of multiple data bits between the computing device and the network access device. The data path circuitry may be controlled to prevent all data bits from being transferred to the network access device.

In accordance with another aspect of the disclosure, the PHY device and the MAC device may be configured to support Ethernet data communication between the computing device and the network access device.

In accordance with a further aspect of the disclosure, a controller may be provided for supplying the data path circuitry with a unidirectional mode signal to set the data path circuitry into the unidirectional signal transfer mode, and for supplying the data path circuitry with a bidirectional mode signal to set the data path circuitry into a bidirectional signal transfer mode.

In accordance with a method of the disclosure, the following steps may be carried out to provide access of a computing device to a computing resource:
coupling the computing device to a network access device configured for enabling access to the computing resource, and
selectively setting an interface between the computing device and the network access device into a unidirectional data transfer mode or a bidirectional data transfer mode.

In the unidirectional data transfer mode, all signals from the computing device may be prevented from being transferred to the network access device

A Media Independent Interface between the computing device and the network access device may be controlled to selectively set the unidirectional data transfer mode or the bidirectional data transfer mode.

In accordance with a further aspect of the disclosure, an access control system is coupled between a computing device and a network link for controlling access of the computing device to a remote computing resource via the network link. The access control system comprises a network access device for providing interface to the network link. A MAC device performs a MAC protocol to support data communication between the computing device and the network access device. A PHY device for connects the MAC device to a physical medium provided for data communication between the computing device and the network access device. Interface circuitry is provided between the PHY device and the MAC device for transferring to the MAC device receive signals from the physical medium, and for transferring to the PHY device transmit signals from the network access device. A controller controls the interface circuitry to prevent the receive signals from being transferred to the MAC device.

The interface circuitry may be configured to selectively establish between the computing device and the network access device a unidirectional data transfer mode or a bidirectional data transfer mode.

In particular, the interface circuitry may be configured to prevent the receive signals from being transferred to the MAC device in the unidirectional data transfer mode, and to enable the receive signals to pass to the MAC device in the bidirectional data transfer mode.

The interface circuitry may be configured to operate as a Media Independent Interface.

Additional advantages and aspects of the disclosure will become readily apparent to those skilled in the art from the following detailed description, wherein embodiments of the present disclosure are shown and described, simply by way of illustration of the best mode contemplated for practicing the present disclosure. As will be described, the disclosure is capable of other and different embodiments, and its several details are susceptible of modification in various obvious respects, all without departing from the spirit of the disclosure. Accordingly, the drawings and description are to be regarded as illustrative in nature, and not as limitative.

### BRIEF DESCRIPTION OF THE DRAWINGS

The drawing figures depict concepts by way of example, not by way of limitations. In the figures, like reference numerals refer to the same or similar elements.

FIG. 1 is a diagram illustrating a general concept of accessing remote computing resources using a controlled interface of the present disclosure.

FIG. 2 is a diagram illustrating an exemplary embodiment of the controlled interface of the present disclosure.

### DETAILED DISCLOSURE OF THE EMBODIMENTS

The present disclosure will be made with an example of a controlled Media Independent Interface (MII) provided between a user computing device and a network access device. It will become apparent, however, that the concepts described herein are applicable to any physical interface that may be arranged on a path over which a user computing device accesses computing resources. For example, the controlled interface of the present disclosure may be used for accessing grid computing systems or cluster computing systems.

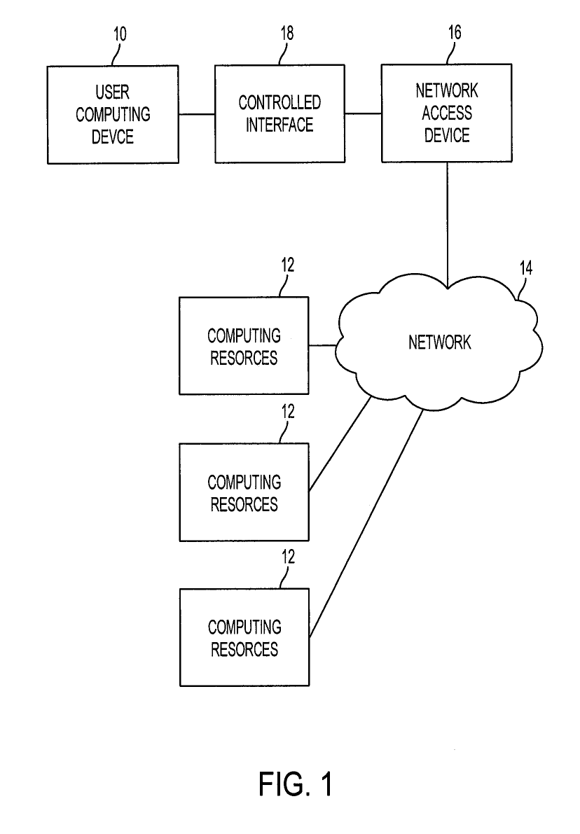

FIG. 1 illustrates an access system for enabling a user computing device 10 to access remote computing resources 12 via a network 14, such as the Internet. The user computing device 10 may be any device capable of accessing remote computing resources, such as a Personal Computer (PC), a mobile station, a data monitor, etc. The remote computing resources 12 may be any computing resources outside of the user computing device 10. For example, the remote computing resources 12 may be cloud resources offered by a cloud provider. Another example of the remote computing resources 12 are resources of a computing grid.

The access system may include a network access device 16 for providing a local computing environment that may be controlled by providers of remote computing resources to control user's access to the remote computing resources. In particular, the network access device 16 may provide a sandbox for executing codes and programs involved in user's operations with the remote computing resources. For example, the network access device 16 may be implemented in a manner similar to the implementation of a cloud secured access device disclosed in our U.S. patent application Ser. No. 12/724,801 filed on Mar. 16, 2010, entitled “Secure Access Device for Cloud Computing,” and incorporated herewith by reference.

In accordance with the present disclosure, a controlled interface 18 is provided between the user computing device 10 and the network access device 16 for controlling data transfer between the user computing device 10 and the network access device 16. In particular, the interface 18 may be selectively controlled to provide a unidirectional data flow from the network access device 16 to the user computing device 10 so as to prevent any signals from being transferred from the user computing device 10 to the network access device 16.

Data transfer between the user computing device 10 and the network access device via the controlled interface 18 may be performed using any data transfer protocol that support a unidirectional data transfer. For example, a User Datagram Protocol (UDP) may be used. The UDP enables computer applications to send messages, referred to as datagrams, to other hosts on an Internet Protocol (IP) network without requiring prior communications to set up special transmission channels or data paths. In particular, UDP does not require hand-shaking procedures, and therefore, can support a unidirectional data flow.

The interface 18 may be controlled in accordance with a security policy established by a provider of computing resources being accessed by the user computing device 10. The security policy may take into consideration vulnerability of the computing resources to eavesdropping and malicious attacks, sensitivity of remotely stored information, geographical location of the user computing device in a potentially dangerous region, access history associated with the IP address of the user computing device and other factors.

Based on the security policy, a provider of computing resources may control the interface 18 so as to establish only a unidirectional data transfer from the network access device 16 to the user computing device 10, preventing any signals from being transferred from the user computing device 10 to the cloud or grid. Alternatively, the provider may allow a bidirectional data transfer to be performed between the user computing device 10 and the network access device 16.

For example, to prevent possible malicious attacks, a cloud provider is able to control the interface 18 so as to prevent any data from being transferred from a potentially dangerous user computing device 10 to the cloud. On the other side, the controlled interface 18 is configured to enhance usability of the cloud access because even a user prevented from transmitting data to the cloud would still be able to receive data from the cloud and to use her computing device for operating with cloud resources.

Also, the controlled interface 18 enhances security of data stored in computing devices of users who become victims of malicious attacks. In particular, even if a hacker is able to plant the information transmitting malware, such as a key logging program, into a user computing device, the sensitive information would not be transferred from the user computing device to the hacker.

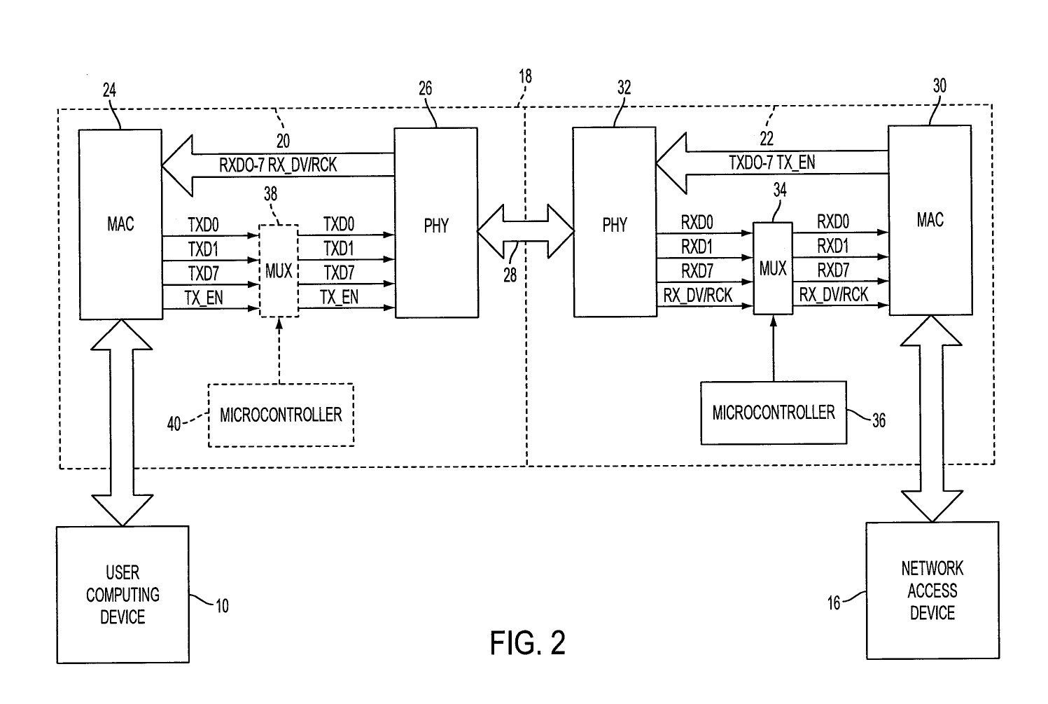

As shown in FIG. 2, the controlled interface 18 may include first and second interface sections 20 and 22. The first interface section 20 is coupled to the user computing device 10, whereas the second interface section 22 is coupled to the network access device 16. The first interface section 20 includes a Media Access Control (MAC) device 24 which is a link layer device attached to the user computing device 10 and providing a MAC address to uniquely identify the user computing device 10. A physical layer (PHY) device 26 connects the MAC device 24 to a physical medium 28 provided between the user computing device 10 and the network access device 16. The second interface section 22 includes a MAC device 30 attached to the network access device 16 and providing a MAC address to uniquely identify the network access device 16. A PHY device 32 connects the MAC device 30 to the physical medium 28.

For example, the MAC devices 24 and 30, and the PHY devices 26 and 32 may be link layer and physical layer devices complying with the Ethernet standard IEEE 802.3. The physical medium 28 may be an Ethernet coaxial cable, twisted pair or optical fiber. Specific implementations of Ethernet physical layers in the interfaces 20 and 22 depend on a data transmission rate and a type of a physical medium. In particular, the 10BASE-T physical layer may be used for the 10 Mbit/s data transmission over the copper twisted pair cabling, the 100Base-T layer may be used for 100 Mbit/s Ethernet and the 1000Base-T layer may be implemented for the Gigabit Ethernet.

A first media independent interface (MII) may be provided between the MAC device 24 and the PHY device 26, and a second MII may be provided between the MAC device 30 and the PHY device 32. The first and second MII interfaces may be implemented in accordance with an Ethernet data rate as a MII interface defined in the IEEE 802.3u standard for a Fast Ethernet (i.e. up 100 Mbit/s) or as Gigabit MII (GMII) for a Gigabit Ethernet (i.e. up to 1000 Mbit/s). Also, the first and second MII interfaces may be implemented as Reduced Gigabit MII (RGMII) that uses the reduced number of data pins compared with GMII.

As defined in the IEEE Ethernet standard, signals transferred over each MII interface include receive signals RX corresponding to signals received by a MAC device, and transmit signals TX corresponding to signals transmitted from the MAC device. For example, in the GMII for the UDP, the receive signals may include receive data signals RXD0-RXD7 representing 8-bit data received by the corresponding MAC device 24 or 30 and a data valid/clock signal RX_DV/RCK providing timing and indicating that the receive data are valid; and the transmit signals include transmit data signals TXD0-TXD7 representing 8-bit data transmitted from the corresponding MAC device 24 or 30 and a transmitter enable signal TX_EN indicating that the MAC device 24 or 30 is enabled to transmit data.

In an exemplary embodiment of the present disclosure, a data flow via the second MII arranged in the second interface section 22 may be controlled to establish a unidirectional data transfer mode or a bidirectional data transfer mode between the user computing device 10 and the network access device 16. In particular, a multiplexer (MUX) 34 may be provided on the path of the receive signals RXD0-RXD7, and RX_DV/RCK supplied from the PHY device 32 to the MAC device 30. The multiplexer 34 may be controlled by a microcontroller 36 to prevent the receive signals RXD0-RXD7, and RX_DV/RCK from being forwarded to the MAC device 30. The microcontroller 36 may provide the multiplexer 34 with a unidirectional mode signal to establish a unidirectional data transfer between the user computing device 10 and the network access device 16, and with a bidirectional mode signal to establish a bidirectional data transfer between the user computing device 10 and the network access device 16.

For example, when the microcontroller 36 provides the multiplexer 34 with the unidirectional mode signal, the multiplexer 34 may connect to the ground receive nodes RXD0-RXD7 and RX_DV/RCK provided to receive the respective receive signals. As a result, the receive signals RXD0-RXD7, and RX_DV/RCK are prevented from being forwarded to the MAC device 30. In this mode, the transmit signals TXD0-TXD7 and TX_EN will continue to be transmitted from the MAC device 30 to the PHY device 32. When the microcontroller 36 provides the multiplexer 34 with the bidirectional mode signal, the multiplexer 34 allows the receive signals RXD0-RXD7, and RX_DV/RCK to pass to the MAC device 30.

Hence, in the unidirectional data transfer mode, all signals from the PHY device 32 are prevented from being forwarded to the MAC device 30. As a result, no signals from the user computing device 10 may be forwarded to the network access device 16. However, the user computing device 10 is enabled to receive all signals forwarded from the network 14 by the network access device 16. In the bidirectional data transfer mode, the user computing device 10 is capable of transmitting and receiving any signals.

The microcontroller 36 may control the multiplexer 34 in accordance with the security policy established by a provider of computing resources being accessed by the user computing device. For example, the microcontroller may be programmed to set the unidirectional data transfer mode for particular users. Alternatively, a data transfer mode for a user may be switched from the bidirectional data transfer mode to the unidirectional data transfer mode, when the user requests access to particular computing resources.

In accordance with an alternative exemplary embodiment of the present disclosure, a data transfer mode between the user computing device 10 and the network access device 16 may be set by controlling the first MII in the first interface section 20. In particular, a multiplexer 38 may be provided on the pass of transmit signals TXD0-TXD7 and TX-EN transferred from the MAC device 24 to the PHY device 26. A microcontroller 40 may be arranged to control the multiplexer 38.

The microcontroller 40 may provide the multiplexer 38 with a unidirectional mode signal to establish a unidirectional data transfer between the user computing device 10 and the network access device 16, and with a bidirectional mode signal to establish a bidirectional data transfer between the user computing device 10 and the network access device 16. For example, when the microcontroller 40 provides the multiplexer 38 with the unidirectional mode signal, the multiplexer 38 may connect to the ground transmit nodes TXD0-TXD7, and TX_EN provided to receive the respective transmit signals. Hence, the transmit signals TXD0-TXD7, and TX_EN are prevented from being forwarded to the PHY device 26. In this mode, the receive signals RXD0-RXD7 and RX_DV/RCK will continue to be transmitted from the PHY device 26 to the MAC device 24. When the microcontroller 40 provides the multiplexer 38 with the bidirectional mode signal, the multiplexer 38 allows the transmit signals TXD0-TXD7, and TX_EN to pass from the MAC device 24 to the PHY device 26.

Hence, in the unidirectional data transfer mode, all signals from the MAC device 24 are prevented from being forwarded to the PHY device 26. As a result, no signals from the user computing device 10 may be forwarded to the network access device 16. However, the user computing device 10 is enabled to receive all signals forwarded from the network 14 by the network access device 16. In the bidirectional data transfer mode, the user computing device 10 is capable of transmitting and receiving any signals.

The foregoing description illustrates and describes aspects of the present invention. Additionally, the disclosure shows and describes only preferred embodiments, but as aforementioned, it is to be understood that the invention is capable of use in various other combinations, modifications, and environments and is capable of changes or modifications within the scope of the inventive concept as expressed herein, commensurate with the above teachings, and/or the skill or knowledge of the relevant art. For example, as one skilled in the art would realize, the controlled interface of the present disclosure may be selectively set into a unidirectional mode or a bidirectional mode of data transfer using any one of multiplexers 34 and 38 or both of these multiplexers.

The embodiments described hereinabove are further intended to explain best modes known of practicing the invention and to enable others skilled in the art to utilize the invention in such, or other, embodiments and with the various modifications required by the particular applications or uses of the invention.

Accordingly, the description is not intended to limit the invention to the form disclosed herein. Also, it is intended that the appended claims be construed to include alternative embodiments.

What is claimed is:

1. An access control system coupled between a computing device and a network link for controlling access of the computing device to a remote computing resource via the network link, the access control system comprising:
a network access device for providing interface to the network link,
a Media Access Control (MAC) device for performing a MAC protocol to support data communication between the computing device and the network access device,
a physical layer (PHY) device for connecting the MAC device to a physical medium provided for data communication between the computing device and the network access device,
interface circuitry provided between the PHY device and the MAC device for transferring to the MAC device receive signals from the physical medium, and for transferring to the PHY device transmit signals from the network access device, and
a controller for controlling the interface circuitry to prevent the receive signals from being transferred to the MAC device.

2. The system of claim 1, wherein the interface circuitry is configured to selectively establish between the computing device and the network access device a unidirectional data transfer mode or a bidirectional data transfer mode.

3. The system of claim 2, wherein the interface circuitry is configured to prevent the receive signals from being transferred to the MAC device in the unidirectional data transfer mode, and to enable the receive signals to pass to the MAC device in the bidirectional data transfer mode.

4. The system of claim 1, wherein the interface circuitry is configured to operate as a Media Independent Interface.

5. A method of providing access of a computing device to a computing resource comprising the steps of:
coupling the computing device to a network access device configured for enabling access to the computing resource, and
selectively setting an interface between the computing device and the network access device into a unidirectional data transfer mode or a bidirectional data transfer mode.

6. The method of claim 5, wherein all signals from the computing device are prevented from being transferred to the network access device in the unidirectional data transfer mode.

7. The method of claim 6, wherein a Media Independent Interface between the computing device and the network access device is controlled to selectively set the unidirectional data transfer mode or the bidirectional data transfer mode.

8. A system for controlling data communication between a computing device and a network access device over a physical medium, the system comprising:
a Media Access Control (MAC) device for performing a MAC protocol to support data communication between the computing device and the network access device,
a physical layer (PHY) device for connecting the MAC device to the physical medium,
data path circuitry provided between the PHY device and the MAC device for transferring first signals from the computing device to the network access device, and second signals from the network access device to the computing device,
the data path circuitry being controlled to establish a unidirectional signal transfer mode between the computing device and the network access device by preventing the first signals from being transferred to the network access device.

9. The system of claim 8, wherein:
the MAC device is coupled to the network access device for providing a MAC address to identify the network access device,
the data path circuitry is provided between the MAC device and the PHY device to transfer transmit signals from the network access device to the physical medium and to transfer receive signals from the physical medium to the network access device,
the data path circuitry being controlled to prevent the receive signals from being transferred to the MAC device.

10. The system of claim 8, wherein
the MAC device is coupled to the computing device to provide a MAC address identifying the computing device,
the data path circuitry is provided between the MAC device and the PHY device to transfer transmit signals from the computing circuit to the physical medium and to transfer receive signals from the physical medium to the computing device,
the data path being controlled to prevent the transmit signals from being transferred to the PHY device.

11. The system of claim 8, wherein the data path circuitry includes a multi-bit data interface for providing parallel transmission of multiple data bits between the computing device and the network access device.

12. The system of claim 11, wherein the data path circuitry is controlled to prevent all data bits from being transferred to the network access device.

13. The system of claim 8, wherein the PHY device and the MAC device are configured to support Ethernet data communication between the computing device and the network access device.

14. The system of claim 8, further including a controller for supplying the data path circuitry with a unidirectional mode signal to set the data path circuitry into the unidirectional signal transfer mode, and for supplying the data path circuitry with a bidirectional mode signal to set the data path circuitry into a bidirectional signal transfer mode.

15. The system of claim 8, wherein the network access device is configured for providing access of the computing device to a remote computing resource over a network link.
